(19) United States
(12) Patent Application Publication
(10) Pub. No.: US 2023/0391413 A1
(43) Pub. Date: Dec. 7, 2023

(54) Wheeling Motorcycle Control System by Controlling the Angle Variation of the Motorcycle's Axis of Gravity while Moving Forward, Relative to the Horizon

(71) Applicant: Amir Simin Maram, Urmia (IR)

(72) Inventor: Amir Simin Maram, Urmia (IR)

(21) Appl. No.: 18/032,422

(22) PCT Filed: Oct. 18, 2020
(86) PCT No.: PCT/IB2020/059789

§ 371 Date: Jul. 8, 2023

(51) Int. Cl. B62J 27/00; B62J 45/415

(52) U.S. Cl. CPC B62J 27/00; B62J 45/4152

(57) ABSTRACT

Auxiliary training system for single-wheelers with motorcycles, which uses sensors and electrical circuits in the engine system and installs this system on the engine to provide single-wheel motor power for the rider with high or low skills. This system consists of 6 components, which include The main switch of the system is the sensor sensitive to changing the angle in the vertical line, the motor step, the main steering relay, the secondary relay and the wiring circuit of the system. In general, this system, with a sensor sensitive to changing the angle in the vertical line and a motor stepper and steering circuit, can stop the device at the same angle to the angle set by the rider and prevent the motorcycle from returning to the user.

Sport motorcycles in terms of efficiency and application necessarily have a high initial acceleration and the rider always suffers from stress and anxiety due to the lack of control of this vehicle. Provides highly skilled people and those who want to use a motorcycle for the first time. Auxiliary training system for single-wheelers with motorcycles, which uses sensors and electrical circuits in the engine system and installs this system on the engine to provide single-wheel motor power for the rider with high or low skills. This system consists of 6 components, which include The main switch of the system is the sensor sensitive to changing the angle in the vertical line, the motor step, the main steering relay, the secondary relay and the wiring circuit of the system. In general, this system, with a sensor sensitive to changing the angle in the vertical line and a motor stepper and steering circuit, can stop the device at the same angle to the angle set by the rider and prevent the motorcycle from returning to the user.

### TECHNICAL FIELD

Mechanical engineering (F)—Machines or engines in general (F01B)

### BACKGROUND ART

In recent years, a number of manufacturers of motorcycle accessories have made examples of this type of system (limited number) and marketed, but the built systems cannot be installed on motorcycles, so in order to use this type, the device must be in a fixed place. And then the motorcycle was mounted on the machine and restrained and began to practice performing a single wheel movement with the motorcycle, but at the same time the newly designed and built system it is possible that it is installed on the motorcycle and gives the user the option to Each condition (according to the rider's skill—place of performance or training) is available to the user and at any time to prepare the motorcycle to perform the movement (single wheel) and to solve this problem in the new system of controlling the angle of the motorcycle The horizon is used in the forward movement position, which allows the user to determine the safe angle to the level of skill in controlling the motorcycle while moving on the rear wheel by adjusting the angle sensor and preventing the motorcycle from turning and falling. Back and forth to prevent the user.

This paper illustrates and discusses the main features of the motorcycle riding simulator designed and built at the University of Padua over recent years. The simulator has been developed for a variety of purposes: to develop and test electronic devices aimed at improving rider safety and vehicle performance (antilock braking systems, traction control systems, etc.), to investigate different design choices and parameter effects on vehicle dynamics, to train riders, and to study their behaviours in different scenarios (normal riding, dangerous situations, etc.).

According to the previous designs, the present proposed design, by designing, manufacturing and installing on a motorcycle device, provides the conditions for all people who want to use a motorcycle, whether highly skilled people or people who want to use a motorcycle for the first time, and The person starts using the device without stress from the mentioned injuries. In previous designs, the safety system was designed for single-wheel motorcycles, which is operated by a sensor mounted on the front assistance of the motorcycle, or from a barrel-assisted distance detection unit that assists the distance detection unit until after Distance detection in the distance detection unit to prevent the motorcycle from turning on one wheel, after which the engine system is completely shut down and does not allow the rider to maneuver. In foreign examples, a personal vehicle with one-wheel and self-balancing performance is designed specifically for a balanced one-wheeled vehicle that the driver can drive the vehicle with manpower and the vehicle simultaneously Performs a balancing act while driving.

### SUMMARY OF INVENTION

Sport motorcycles have high accelerations. Due to their struggles at controlling these vehicles, their riders have always experienced stress and anxiety. Therefore, installing the proposed system on a motorcycle will make sure that all riders with all skill levels will be able to use these motorcycles and perform a wheeling acrobatic move without any stress. In general, this system has a sensitive-to-angle-variation sensor that is relative to the vertical line, a stepper motor, and a command circuit that can position the vehicle at a wheeling position based on the angle set up by the rider, preventing it from returning to its previous position. And if at any moment, the rider was unable to take the breaks, by automatically taking the brakes and preventing any accidents or possible damages to the rider or the motorcycle, the system helps the rider.

### Technical Problem

The field of motorcycling and auto-racing has high capacities in attracting the youth, which necessitates sports officials to offer more ground for the growth and the development of this field by providing more support and the essential standards in the coming years. One of the attractions of this field is its acrobatic moves, which are attractive to all types of people, and everyone tries to perform them to the best of their skills and abilities. However, despite their unique attractiveness, they include financial and physical damages and dangers. Since automobile manufacturers use up-to-date technologies in manufacturing sport motorcycles, manufacturing motorcycles and their parts can render very high and expensive costs. Although much of the dangers can be avoided by wearing special costumes while practicing these stunt moves, the damages will first affect their riders. However, motorcycle-wise, these damages can render very high repair costs for their riders and considering the existing conditions, transporting these damaged vehicles while changing the practice field can prove to be a hard task for the riders. Therefore, a system that installs on the motorcycle has been designed that by determining the angle, helps the riders to perform a flawless wheeling move, in which they can perform a wheeling without damaging the motorcycle and themselves.

### Solution of Problem

Since sport motorcycles have high accelerations and their riders may experience anxiety and stress while controlling them, by installing this system on the vehicles and in the riders' sights, this system can make controlling them a much easier task for skilled or unskilled beginner riders so that they could use their vehicles without stress. Hence, this designed and prepared system will be installed on the motorcycle, where the riders will be able to activate/deactivate it at any moment at their will, and keeping their motorcycles ready for practice at all times, which at the same time brings no harm to the functionality of their motorcycles. Generally, this system has a sensitive-to-angle-variation sensor that is relative to the vertical line, a stepper motor, and a command relay that can bring up the motorcycle at the desired angle set-up by the rider, and prevent it from returning back to its previous position. This new system facilitates a control system that controls the angle variation of the motorcycle's axis of gravity while moving forward, relative to the horizon, which helps the riders based on their skill levels to keep their safe wheeling angle by adjusting the angle sensor and preventing the vehicle from turning and crashing over them.

This acrobatic move would become more delightful while practicing, only when the riders are skilled enough and have a good harmony between their minds and body parts. By bringing up the front wheel on a vertical line and changing the center of the gravity (by considering the rider's weight), and keeping the balance of the motorcycle by applying brake when it's necessary and bringing back the vehicle to its previous position, this system can play a more important role in helping the riders when they do not have the proper skills. If the riders could not apply brakes at a specific moment, this system will do it automatically and prevent damaging the riders and their motorcycle. Also, it's noteworthy to mention that many active athletes in this field may not be able to flawlessly perform this move in a beginner or a professional level, since they accumulate stress and anxiety while evaluating the possible dangers. Therefore, this system can help these athletes in a positive way.

The components and the functions of the wheeling auxiliary training system with motorcycles are as follows:

1. The main On/Off switch: This switch turns on and off the system as easily as possible, since it's installed within the rider's field of view. An LED has installed on the switch, which tells the status (being on or off) of the switch to the riders, so that if the LED is turned off, the system is off and if the LED is turned on, the system is on.

2. A sensitive-to-angle-variation sensor that is relative to the vertical line: This sensor facilitates mercury metal, in which by changing the angle of the sensor, (considering gravity and the liquid properties of the mercury metal) the level of mercury will also change accordingly.

Sport motorcycles have high initial acceleration, and they confront many tensions and ground unevenness in the off-road field of this sport. Therefore, in high accelerations and in uneven grounds, there's a possibility of the mercury to be accumulated at the far-end of the sensor, where it can disrupt the functionality of it. Thus, a special chamber has been considered for directing the mercury into the sensor for improving its performance in harsh conditions. Also, based on the riders' skills, this system can set up to function in different positions and within custom settings. Finally, there are two metal pins within the sensor, where the mercury is placed between them for proper conduction, sending the necessary commands to the main relay, and activating the system.

3. Stepper motor: This section has 6 parts, including the electromotor, the gearbox, a metal frame, the on/off current sensor, a crankshaft, and a towing wire that works with an input voltage of 12 volts and provides adequate power to the system in pressing the brake pedal when necessary. Also, it has a high operating speed, power, and torque force. When the electric current turns on, the electromotor will activate and the gearbox will start rotating accordingly. At the far end of the gearbox, there's a crankshaft that pulls a towing wire that transfers the power created by the electromotor and the gearbox to the rear wheel brake pedal that is connected to it. Beside the crankshaft, there's an on/off electric current sensor that keeps the rotation of the electromotor as long as the brake pedal has not returned to its previous neutral position. In some cases, when the brake pedal is under pressure, based on the position that the angle sensor is in, it sends a deactivation command to the system, which makes the rear wheel brake pedal to be kept under pressure. It's at this position that the sensor takes the responsibility of keeping the electric current turned on, at which it continues to do so until the brake pedal returns to its normal position and releases the wheel, bringing the motorcycle to its normal position on its route. It's noteworthy to mention that the on/off current sensor takes its command directly from the crankshaft and puts the start/stop location point of the crankshaft to an optimal position. Regarding the towing wire, it's necessary to mention that a 2-mm-diameter towing wire with two plastic and metal protection layers was used that properly transfers power from the stepper motor to the brake pedal and is connected to the brake pedal with a clamp.

4. Main command relay: The command relay has the responsibility of turning on and off the electrical current connectors, which uses a 12 v battery and comprises of 11 electrical current input and output pins. This relay works as follows: at the first step, when the rider activates the main switch, the system activates and by changing the sensor angle, the angle of the electric current transfers to the command relay, and considering the stepper motor needing a high amount of electrical amperage for start-up, there should be a relay to transfer this required electrical amperage to the stepper motor. Another responsibility of the main relay is turning off the electric current of the spark plug's ignition coil. Controlling the motorcycle by only applying the brakes while performing a wheeling is not sufficient, since the brakes' force would not be adequate against the force created by the engine and do not return it to its original position. At this point, the main relay will have the responsibility of turning off the electric current moving to the spark plug's ignition coil, which creates two optimizing modes for controlling the motorcycle. Firstly, the engine would not produce any force and secondly, the engine itself transforms into a mechanical brake system, helping the control and returning the motorcycle to its original position with a faster functionality. Of course, in motorcycles with injector refueling systems, a process can be considered for turning off the gasoline pump, and since the pressure from the simultaneous high amperage consumption of the stepper motor and the gasoline pump in these motorcycles can damage the battery or the power generation system, thus, by turning off the electric current, one can also turn off the electric current of the motorcycles' gasoline pump ignition systems. In some sport motorcycles, especially off-road ones, to reduce the weight of the motorcycles, manufacturing companies use a power generating system that does not require any batteries, but based on the power consumption of the motorcycle, they install a suitable electrical power generator on the motorcycle that is only adequate for normal electrical consumption of the vehicle. If the above systems had to be installed on such motorcycles, there'd be a chance of disruption in power generation of the two cases (motorcycle and the above system). Therefore, since the electric consumption of the stepper motor is almost equal to the electric consumption of the gasoline pump of these motorcycles (with injector refueling systems), if the ignition power turns off at the same time as the gasoline pump has turned off, the motorcycle or its power generator will not experience any problems.

5. Sub-relay: Alongside the main relay, there's a sub-relay that is responsible for turning off the electrical current required for ignition and is directly connected to the main relay. We have used this relay for two reasons: firstly, there's a deficiency of connector pins for creating an electrical connection between the electrical components, and secondly, the working origin of the system sensors is based on their negative poles. This negative pole is also used for turning off the motorcycle. Therefore, motorcycle manufacturers provide a button on the steering head that by pressing it, the positive pole will connect the spark plug to the negative pole, turning off the motorcycle as a result. Since this wheeling system also takes its commands from the negative pole which is shared between the engine's inertial switch, in ordinary situations, if the motorcycle inertial switch button gets pressed (in order to turn off the vehicle), the above-mentioned system will be activated momentarily. For this reason, sub-relay helps the main relay in order to solve this problem. The sub-relay contributes to the system within the following method: until the main relay has not activated, by pressing the motorcycle inertial switch button, only the vehicle turns off and no change will be applied to the wheeling system of the vehicle.

6. Circuit wiring: The circuits used in this system consist of wires that are responsible for providing electrical connections between the sensors, the stepper motor, and the main relay. They also send commands from the sensors to the main relay and transfer the electrical current to the stepper motor. These can be seen in the provided wiring diagrams (circuit no# 1). There's also a diode in the circuit wiring that prevents the generated voltage from returning to the system. In fact, its responsibility is to prevent and direct the electric current input to the stepper motor and direct the electric current output generated in the stepper motor to the system's power supply circuit.

### Advantage Effects of Invention

1. Complete installation on a motorcycle once and for all
2. Ready motorcycles always and everywhere to practice and perform dramatic movements
3. Prevent physical injuries to the rider in training and performing dramatic movements
4. Prevent injuries to the motorcycle itself in training and performing dramatic movements
5. Creating comfortable and safe conditions for learning, practicing and performing dramatic movements
6. Create easy conditions in terms of space and time to practice
7. Creating ideal psychological and psychological conditions for the motorcyclist during training and running

### BRIEF DESCRIPTION OF DRAWINGS

FIG. 1: Wiring circuit and connections of single wheel auxiliary system

FIG. 2: Schematic diagram of a single wheel auxiliary system

FIG. 3: Inside sensor angle view

FIG. 4: Interior view of crankshaft plate and engine stop sensor

FIG. 5: Location of the main system key

FIG. 6: Angle sensor

FIG. 7: Inside sensor angle view

FIG. 8: Engine overview

FIG. 9: Electric motor and gearbox

### DESCRIPTION OF EMBODIMENTS

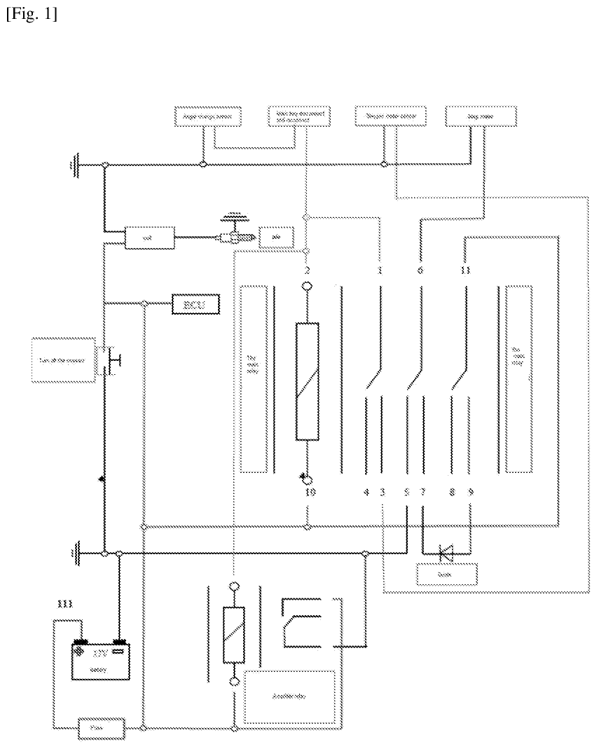

FIG. 1: Wiring circuit and connections of single wheel auxiliary system

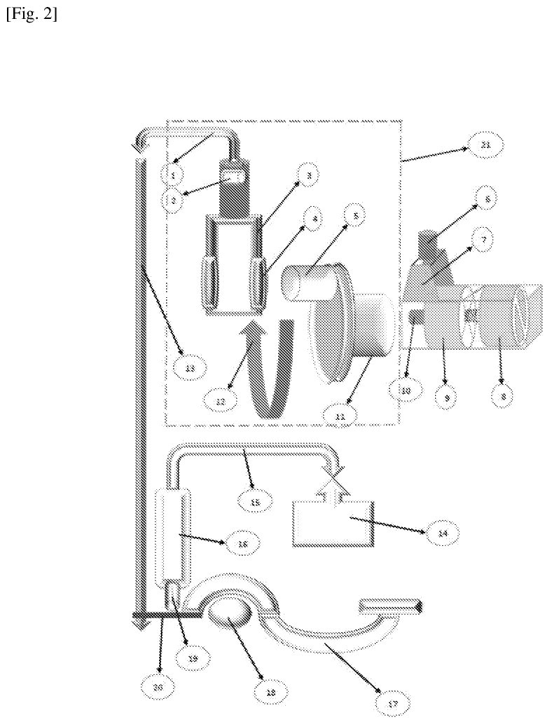

FIG. 2: 1 and 13—Towing wire which is responsible for transmitting power from the gearbox to the rear brake pedal, which consists of two parts of the towing and cover bracket. 2—Towing support bracket (metal) It is in charge of the towing wire. 4—The location of the crankshaft rod to transmit the crankshaft force to the shaft. 5—The fixed crankshaft rod to transfer the crankshaft force to the shaft (metal). Crankshaft 8—DC electric motor which is responsible for generating power 9—Gearbox which is responsible for increasing the power and torque of the electric motor Plastic shell with metal gears) 10—Gearbox output shaft which supplies the power produced by the gearbox to the crankshaft Transmits (metal) 11—Connection of crankshaft to gearbox output shaft (metal) 12—Symbol for rotation of crankshaft 14—Motorcycle rear wheel brake pump 15—Brake oil steering valve between main brake pump and rear wheel brake pump 17—Motorcycle rear wheel brake pedal (metal) 18—Brake pedal holder shaft (metal) 19—Intermediary between brake pedal Main brake pump (metal) 20—Brake pedal pressure transfer base to main brake pump (Metal) 21—Internal accessories of crankshaft chamber.

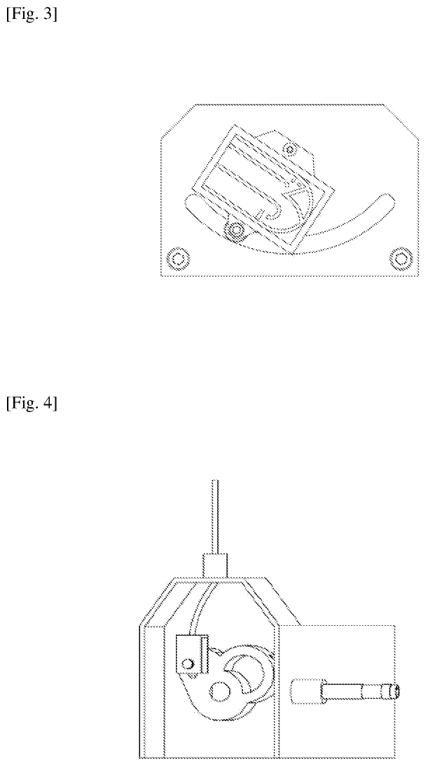

FIG. 3: Inside sensor angle view

FIG. 4: Interior view of crankshaft plate and engine stop sensor

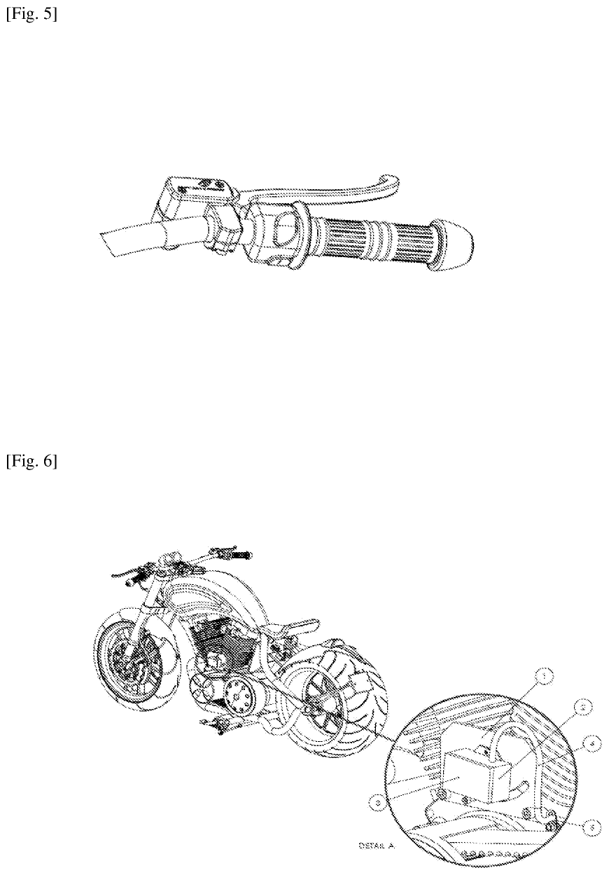

FIG. 5: Location of the main system key

FIG. 6: 1—Angle sensor main chassis 2—Angle sensor protective body 3—Angle sensor metal cap 4—Platinum cable inside the sensor 5—Sensor cable holder.

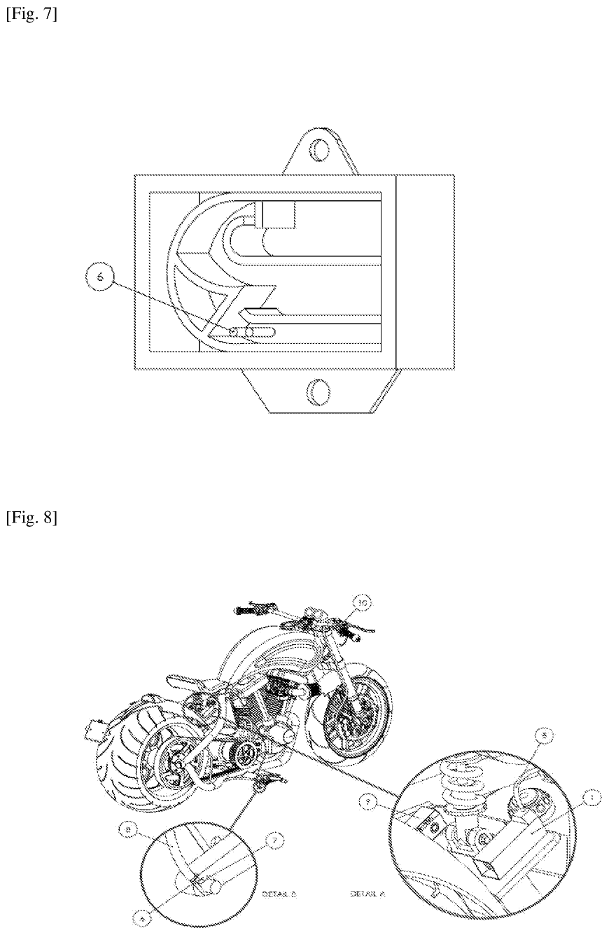

FIG. 7: 6—Internal plates of the sensor.

FIG. 8: 1—Metal body of electric motor and gearbox 6—Holding bracket of tow wire on brake pedal 7—Tow wire 8—Tow cover of crankshaft output 9—Main steering relay.

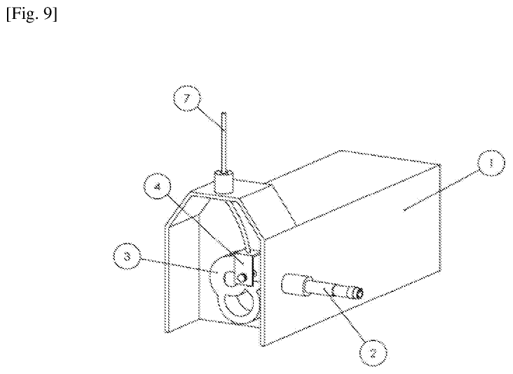

FIG. 9: 1—Metal body and protector of electric motor and gearbox 2—Stop sensor of electric motor 3—Crankshaft 4—Clamp connection of tow wire to crankshaft 7—Output of tow wire.

### EXAMPLES

Sport motorcycles in terms of efficiency and application necessarily have a high initial acceleration and the rider always suffers from stress and anxiety due to the lack of control of this vehicle. And what people who want to use a motorcycle for the first time in general. Stop the angle and prevent the motorcycle from returning to the user.

### INDUSTRIAL APPLICABILITY

This system can be installed on all motorcycles, including off-road, riding and racing, etc.

1. What has proposed is an auxiliary training system for performing wheeling's by a motorcycle that by facilitating sensors and electrical circuits in its engine system, makes performing them much easier for skilled or unskilled riders.

2. According to 1, the above system comprises of 6 parts: the main on/off switch, a sensor that is sensitive to angle variations relative to a vertical line, the stepper motor, the main command relay, sub-relay, and circuit wiring.

3. According to 2, the main on/off switch is installed on the steering head.

4. According to 2, the sensitive-to-angle-variations sensor relative to the vertical line has a special chamber that has considered for directing the mercury into the sensor for improving its performance. Also, there are two metal pins within the sensor, where the mercury is placed between them for proper conduction, sending the necessary commands to the main relay, and activating the system.

5. According to 2, when necessary, pressing the brake pedal will be done by the stepper motor, which has 6 parts including the electromotor, the gearbox, a metal frame, the on/off current sensor, a crankshaft, and a towing wire.

6. According to 5, when the electric current turns on, the electromotor will activate and the gearbox will start rotating accordingly. At the far end of the gearbox, there's a crankshaft that pulls a towing wire that transfers the force created by the electromotor and the gearbox to the rear wheel brake pedal that is connected to it.

7. According to 5 and 6, beside the crankshaft, there's an on/off electric current sensor that keeps the rotation of the electromotor, as long as the brake pedal has not returned to its previous neutral position.

8. According to 7, when the brake pedal is under pressure, based on the position that the angle sensor is in, it sends a deactivation command to the system, which makes the rear wheel to take brakes.

9. According to 5, the on/off current sensor takes its commands directly from the crankshaft and puts the start/stop location point of the crankshaft to an optimal position. According to 5, power transfers from the stepper motor to the brake pedal by a towing wire; a 2-mm-diameter towing wire with two plastic and metal protection layers that are connected to the brake pedal with a clamp.

11. According to 2, the command relay is responsible for turning on and off the electrical current connectors, which uses a 12v battery and comprises of 11 electrical current input and output pins.

12. According to 11, the stepper motor requires a high amount of electrical amperage after the start-up. Also, the main relay is responsible for turning off the electric current moving to the spark plugs ignition coil.

13. According to 12, by installing this system on motorcycles, and to prevent disruption in motorcycles' power generation, the electric consumption of the stepper motor is almost equal to the electric consumption of the gasoline pump of motorcycles with injector refueling systems. When the ignition power turns off at the same time as the gasoline pump has turned off, the motorcycle or its power generator will not experience any problems.

14. According to 2, a sub-relay is responsible for turning off the electrical current required for the ignition and it is used for two reasons.

15. According to 14, due to the deficiency of connector pins for creating an electrical connection between the electrical components at the main relay, a sub-relay has been used.

16. According to 14, the working origin of the system sensors is based on their negative poles. Also, for turning off the motorcycle, negative poles are used. This is why the sub-relays are used.

17. According to 2, circuit wirings are responsible for providing electrical connections between the sensors, the stepper motor, and the main relay. They also send commands from the sensors to the main relay and transfer the electrical current to the stepper motor.

18. According to 17, There's a diode in the circuit wiring that prevents the generated voltage from returning to the system. In fact, its responsibility is to prevent and to direct the electric current input to the stepper motor and to direct the electric current output generated in the stepper motor to the system's power supply circuit.
